(19) United States
(12) Patent Application Publication
(10) Pub. No.: US 2009/0126353 A1
(43) Pub. Date: May 21, 2009

(54) Oxidation Catalyst for NH3 and an Apparatus for Treating Slipped or Scripped NH3

(75) Inventors: Hyun-Sik Han, Kyungki-do (KR); Eun-Seok Kim, Gyeonggi-do (KR)

Correspondence Address: Ballard Spahr Andrews & Ingersoll, LLP, SUITE 1000, 999 PEACHTREE STREET, ATLANTA, GA, 30309-3915, US

(73) Assignee: Heesung Catalysts Corporation, Shiheung-city, Kyungki-do (KR)

(21) Appl. No.: 11/988,265

(22) PCT Filed: Nov. 7, 2005
(86) PCT No.: PCT/KR2005/003750

§ 371 Date: Jan. 4, 2008

(30) Foreign Application Priority Data
Jul. 6, 2005 (KR) 10-2005-0060930
Oct. 4, 2005 (KR) 10-2005-0092994

(51) Int. Cl. F01N 3/035; B01J 29/00; B01J 23/72

(52) U.S. Cl. 60/297; 502/74; 502/331; 422/177

(57) ABSTRACT

Disclosed herein are an ammonia oxidation catalyst and a system for treating slipped ammonia or waste ammonia using the oxidation catalyst. More specifically, disclosed are an ammonia oxidation catalyst comprising either Cu-containing zeolite impregnated with platinum or Cu-containing alumina impregnated with platinum, which has improved low-temperature activity to oxidize ammonia generated in a mobile source or fixed source system and is used to inhibit the formation of nitrogen oxides, as well as a system for treating ammonia contained in vehicle exhaust gas, a chemical reactor system and an environmental device and system, which include the oxidation catalyst.

### TECHNICAL FIELD

The present invention relates to an ammonia oxidation catalyst and a system for treating slipped ammonia or waste ammonia using the same, and more particularly to an ammonia oxidation catalyst comprising either Cu-containing zeolite impregnated with platinum or Cu/Si-containing alumina impregnated with platinum, which has improved low-temperature activity of oxidizing ammonia generated in a mobile source or fixed source system and is used to inhibit the formation of nitrogen oxides caused by ammonia, as well as a system for the treatment of ammonia contained in vehicle exhaust gas, a chemical reactor system and an environmental device and system, which include said ammonia oxidation catalyst.

### BACKGROUND ART

A selective catalytic reduction (SCR) system for the control of nitrogen oxides (NOx) generated from systems is generally used in an ammonia preparation process, industrial processes that use ammonia as main raw material or subsidiary raw material, and the fields of multi-purpose boilers, engines, furnaces and vehicle engines. The SCR or selective non-catalytic reduction (SNCR) system is used to reduce the emission of nitrogen oxides from exhaust gas containing NOx, particulate matter and hydrogen carbon, which is discharged from chemical factories, boilers, engines, furnaces, and vehicle engines. Generally, reducing agent ammonia in a fixed source SCR system is injected into an exhaust gas stream in an exhaust gas treatment system in which an SCR reduction catalyst bed is disposed. The injected ammonia catalytically reduces a large amount of nitrogen oxide contained in the exhaust gas so as to convert the nitrogen oxide into water and nitrogen. Because the nitrogen oxide removal catalyst used in the SCR system is carefully treated and expensive, it is preferable to control the stoichiometry of exhaust gas/ammonia/catalyst reactions, but there is a problem of secondary contamination due to the slip of ammonia unreacted with NOx. Meanwhile, methods of using a urea or ammonia SCR catalyst to remove nitrogen oxides from the exhaust gas of lean burn engines have been studied, but the problem caused by ammonia slip in vehicles still remains as a problem to be solved, like the problem in the fixed source system. As used herein, the term “ammonia slip” is defined as a phenomenon in which ammonia gas, which is injected for the purpose of reacting with nitrogen oxides contained in exhaust gas discharged from the fixed source or mobile source nitrogen oxide generator, does not participate in an NOx reduction reaction due to various causes, but rather is emitted to the external environment. The term “slipped ammonia” is defined to mean ammonia which is slipped and emitted to the external environment. Meanwhile, separate from the problem of ammonia slip, the need to improve technology for the removal of waste ammonia gas has also been noted in an ammonia preparation process, industrial processes that use ammonia as main raw material or subsidiary raw material, and an industrial field in which ammonia gas is emitted as a byproduct of other chemical processes.

The present invention relates to a catalyst composition, which is effectively used to oxidatively degrade either waste ammonia (NH₃) emitted from the fixed source system or ammonia slipped from the fixed source SCR and SNCR systems and the mobile source SCR system into nitrogen (N₂) and water (H₂O) under preferred temperature conditions and, at the same time, to minimize nitrogen oxides caused by side reactions, as well as a system for treating ammonia using the above catalyst composition.

In a catalytic reaction for ammonia oxidation, the activity and life cycle of the catalyst are always problematic, but pressure loss caused by the shape of the catalyst is also a great problem. Thus, when a large amount of gas is treated, as in the case of exhaust gas treatment, there is significant pressure loss, which results in an increase in the power consumption of blowers and the like, thus increasing operational costs. In an attempt to solve this pressure loss problem, the prior art (Korean Patent Publication No. 1981-1294) relating to ammonia oxidation catalysts discloses a method of preparing an oxidation catalyst showing excellent strength without causing the pressure loss problem, the oxidation catalyst being prepared by making the surface layer of a steel material, having a given shape such as an annular shape, honeycomb shape or plate shape, porous, oxidizing the steel material having the porous surface to obtain a catalyst substrate, and supporting platinum on the catalyst substrate. According to the disclosure of said patent, an aqueous chloroplatinate solution is most suitable as a dipping solution for use in supporting platinum on the catalyst substrate. Specifically, the catalyst preparation method disclosed in said patent comprises the steps of: alloying the surface layer of a steel material, having an annular shape or honeycomb, with aluminum; subjecting the steel material having the alloy layer to aluminum dissolution using a solution capable of dissolving aluminum, thus making the steel material surface layer porous; oxidizing the steel material according to known processes to obtain a catalyst substrate; dipping the oxidized steel material in a chloroplatinate solution adjusted to weak alkalinity using barium hydroxide; and removing the treated catalyst substrate from the solution, followed by drying.

However, it was found that the known ammonia oxidation catalyst has insufficient low-temperature activity and also cannot efficiently inhibit NOx produced in side reactions.

Although exhaust gas treatment systems for diesel engines or gasoline engines are known, an example of application of the NH oxidation catalyst according to the present invention to a system is not yet known.

A known exhaust treatment system for use in mobile sources such as diesel engines comprises: (a) an exhaust system through which exhaust gas flows; (b) a selective catalytic reduction catalyst placed in the exhaust system, the catalyst serving to catalyze the reduction of NOx into nitrogen by ammonia and adsorbing and desorbing ammonia during an engine cycle; (c) an ammonia source; (d) a means for supplying ammonia from the ammonia source to the catalyst; and (e) a means for intermittently supplying ammonia during the engine cycle. With respect to the exhaust treatment system in the mobile sources, a system for treating slipped ammonia is not yet disclosed.

Also, a known fixed source system for the treatment of exhaust gas comprises: (a) a combustion chamber having no reducing agent-injection unit; (b) a waste heat boiler through which exhaust gas generated in the combustion chamber flows; (c) a dry, semi-dry or wet reaction column; (d) a bag filter; (e) an SCR exhaust treatment system including an ammonia-reducing agent supply unit and a catalyst column; and (f) a means for emitting exhaust gas. However, with respect to the fixed source SCR exhaust gas treatment system, a system for treating slipped ammonia is not yet known.

Meanwhile, a known fixed source NSCR system for the treatment of exhaust gas comprises: (a) a combustion chamber equipped with a reducing agent-injection unit; (b) a waste heat boiler; (c) a reaction column; (d) a bag filter; and (e) a means for emitting exhaust gas. With respect to the fixed source NSCR system for the treatment of exhaust gas, an ammonia treatment system for preventing ammonia, used as a reducing agent, from being emitted to the external environment is not yet known.

Thus, the present invention aims to provide a system for treating slipped ammonia or waste ammonia generated in a mobile source or fixed source SCR reaction or NSCR reaction, or in ammonia-related processes.

### DISCLOSURE OF INVENTION

### Technical Problem

It is an object of the present invention to provide an ammonia oxidation catalyst having improved low-temperature activity in ammonia oxidation reaction.

Another object of the present invention is to provide an ammonia oxidation catalyst, which can inhibit nitrogen oxide formation caused by an ammonia oxidation reaction.

Still another object of the present invention is to apply an ammonia oxidation catalyst having improved low-temperature activity in an exhaust treatment system.

Thus, the ultimate object of the present invention is to provide an ammonia oxidation catalyst, which is used to minimize the formation of nitrogen oxides caused by slipped ammonia or waste ammonia generated from SCR or NSCR reaction or ammonia-related processes in an mobile source or fixed source system and to effectively remove ammonia under preferred temperature conditions, as well as a system for treating ammonia using the ammonia oxidation catalyst.

### Technical Solution

According to the present invention, the above objects can be accomplished by providing a catalyst composition comprising either Cu-containing zeolite impregnated with precious metal (platinum, palladium or rhodium) or Cu/Si-containing alumina impregnated with precious metal, as well as a system for treating ammonia, in which a monolithic ceramic or metal substrate having the composition supported thereon is disposed.

The zeolite, used in the present invention, is an aluminosilicate zeolite-based natural or synthetic zeolite and is selected from the group consisting of metallic or non-metallic ZSM5, zeolite Y, β Zeolite, γ zeolite, and mordenite. The metallic zeolite is preferably Fe-zeolite, Cu-zeolite or Fe/Cu-zeolite, which are ion-exchanged with Fe or Cu. The Fe-zeolite may also be impregnated with Cu. The alumina, used in the present invention, is preferably γ alumina, in which Cu and Si are included or impregnated. The precious metal (platinum, palladium or rhodium), used in the present invention, is impregnated in an amount of less than 1.0 wt %. Said catalyst composition may be coated on a catalyst substrate, and all measurement values with respect to the catalyst composition are based on weights after coating the composition on the substrate.

When Cu is impregnated into zeolite, Cu can be derived from the following copper compounds. Copper ions from the copper compounds can be divalent or trivalent, and examples of the copper compounds include copper nitrate, copper chloride, copper oxide, copper sulfate, copper oxalate, copper acetate, copper carbonate, copper hydroxide, ammonium copper chloride, ammonium copper hydroxide, ammonium copper phosphate and the like, preferred being copper nitrate or copper acetate. Copper is preferably impregnated in an amount of less than 10 wt % based on the total weight of the catalyst. If copper is impregnated in an amount higher than 10 wt %, no additional increase in the catalyst activity will be shown and no advantage in economical terms will be obtained.

The deposition of the catalyst composition on the wall of the substrate made of, for example, monolithic ceramic material or silicon carbide material, can be performed using any conventional method. For example, the substrate can be impregnated with the catalyst composition. Alternatively, the catalyst composition can also be wash-coated on the substrate.

### ADVANTAGEOUS EFFECTS

The present invention relates to an ammonia oxidation catalyst composition comprising either Cu-containing zeolite impregnated with platinum or Cu/Si-containing alumina impregnated with platinum, and a system for treating ammonia using the same. The inventive catalyst composition has excellent low-temperature activity and can inhibit the formation of nitrogen oxides caused by an ammonia oxidation reaction. Specifically, the inventive catalyst composition is used to inhibit the formation of nitrogen oxides caused by slipped ammonia or waste ammonia in a mobile source or fixed source SCR reaction or NSCR reaction, ammonia preparation processes or related processes. Also, in the ammonia treatment system, a substrate having said catalyst supported thereon is placed.

### BRIEF DESCRIPTION OF THE DRAWINGS

FIGS. 1 and 2 show Cu-containing zeolite Y activity and NOx formation as a function of the content of Pt in the catalyst, respectively. In FIGS. 1 and 2, A: Cu/zeolite Y; B: 0.3 wt % Pt-impregnated Cu/zeolite Y; C: 0.5 wt % Pt-impregnated Cu/zeolite Y; and D: 0.7 wt % Pt-impregnated Cu/zeolite Y.

FIGS. 3 and 4 show Pt-impregnated Cu/Si-impregnated alumina activity and NOx formation, respectively. In FIGS. 3 and 4, E: 0.7 wt % Pt-impregnated alumina; H: 0.7 wt % Pt-impregnated Cu/Alumina; and J: 0.7 wt % Pt-impregnated Cu/Si alumina.

FIGS. 5 and 6 show catalyst activity and NOx formation according to the kind of Pt-impregnated Cu-containing zeolite, respectively. In FIGS. 5 and 6, L: 0.7 wt % Pt-impregnated Cu/Fe-Beta (S); O: 0.7 wt % Pt-impregnated Cu/H-Beta (Z); Q: 0.7 wt % Pt-impregnated Cu/ZSM-5; S: 0.7 wt % Pt-impregnated Cu/H-Beta; and U: 0.7 wt % Pt-impregnated Cu/Fe-Beta.

### BEST MODE FOR CARRYING OUT THE INVENTION

Hereinafter, a process for designing a catalyst according to the present invention will be described.

First, the present inventors evaluated the suitability of a Cu-containing zeolite catalyst composition and the effect of platinum content on the catalyst composition and, as a result, found that the Cu-containing zeolite alone had a possibility of acting as an ammonia oxidation (hereinafter, also referred to as “AO”) catalyst, that the low-temperature activity of the catalyst was increased depending on the platinum content, and also that NOx formation was promoted in proportion to the increase in the platinum content.

Then, the present inventors examined whether alumina capable of substituting for the above-described zeolite was suitable for an AG catalyst composition, and evaluated the effect of Cu contents on the alumina catalyst composition. As a result, it was found that, when alumina was used as the catalyst support, it had AO activity, but was negative in terms of NOx formation, and an increase in the Cu content thereof led to a reduction in activity, but was advantageous in terms of NOx formation.

On the basis of these findings, the present inventors examined the suitability of alumina as an AG catalyst according to the content of Si in alumina and, as a result, found that an increase in the content of Si in alumina was advantageous in terms of the formation of NOx formation. Thus, it was found that, when the outlet temperature of NH₃ is maintained at a constant level of about 250° C., the alumina catalyst could also be applied.

However, when the outlet condition of NH₃ in catalyst application sites is not constant, as in vehicles, it is difficult to apply the alumina catalyst support, and thus it is believed that the zeolite catalyst support will be advantageous in wide temperature ranges in terms of AO activity and NOx formation. Also, in selecting zeolite as the catalyst support, the present inventors examined the suitability of zeolite for an AG catalyst according to the Cu content and the type of zeolite, and thus suggested an optimized catalyst composition according to the present invention.

Evaluation tests in all Examples below were conducted under the same conditions. The test conditions were as follows: composition of injected gas: 350-390 ppm of NH₃, 30 ppm of NOx; 5.0% H₂O, 5.0% O₂, and a balance of N₂; and space velocity: 40,000 l/h.

First, Cu-containing-zeolite Y was examined for whether it shows activity suitable for ammonia oxidation. Also, Cu-containing-zeolite Y impregnated with Pt was examined to determine its ammonia oxidation rate at low temperature, and the effect of Pt content on NOx formation.

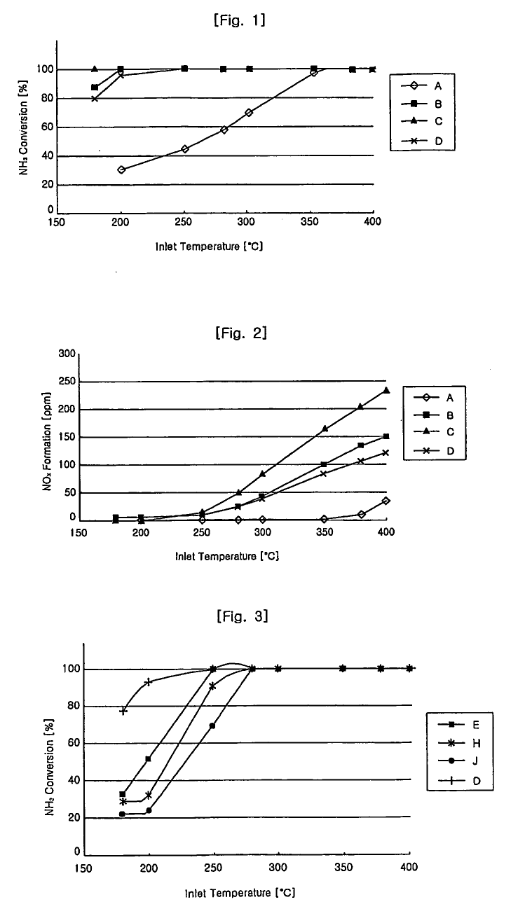

Said evaluation test was conducted on Cu-containing zeolite Y, and Cu-containing zeolite Y catalysts impregnated with each of 0.3 wt %, 0.5 wt % and 0.7 wt %. FIGS. 1 and 2 show ammonia conversion and NOx formation, respectively. In the case of Cu-containing zeolite Y, a conversion rate of 60% was achieved at about 300° C., suggesting that Cu-containing zeolite Y can be used as an AO catalyst at high temperatures. Also, it could be found that an increase in the platinum content thereof led to an improvement in the low-temperature activity thereof, but resulted in an increase in NOx formation. This suggests that Cu-containing zeolite can be used alone as an AO catalyst, but needs to be impregnated with platinum in order to increase the low-temperature activity thereof.

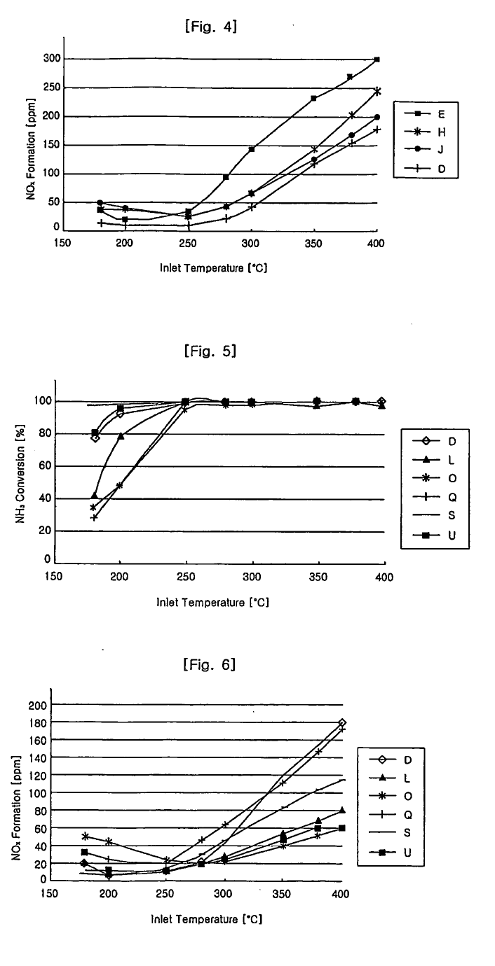

In order to find a suitable Cu content and an alternative support on the basis of the above results, the present inventors evaluated an alumina impregnated with 0.7 wt % platinum, but containing no Cu, a Cu-containing alumina impregnated with 0.7 wt % platinum, and a Cu/Si-containing alumina impregnated with 0.7% platinum, in comparison with Cu-containing zeolite Y impregnated with 0.7 wt % platinum (see FIGS. 3 and 4). The presence of Cu in the catalyst led to a decrease in the low-temperature activity of the catalyst, but was advantageous in terms of the formation of NOx. A result similar to this catalyst was shown for the catalyst containing both Cu and Si. The Cu and Si-containing alumina support was disadvantageous for low-temperature activity compared to zeolite, but showed results similar to those of zeolite with respect to NOx formation.

On the basis of the above results, in order to analyze the qualitative properties of zeolite as a support in consideration of low-temperature activity and NOx formation inhibition, the present inventors conducted evaluations on ZSM5, H-beta and Fe-beta zeolites, each impregnated with 0.7 wt % platinum and containing Cu, under the same conditions, with reference to 0.7 wt % platinum-impregnated Cu-containing zeolite Y (see FIGS. 5 and 6). As a result, it was found that an increase in SAR ratio (silica/alumina ratio) led to a decrease in ammonia oxidation activity, and zeolite-beta, particularly Fe-beta, was more advantageous for low-temperature activity than zeolite Y and ZSM5. Also, the inclusion of Cu in the catalyst provided a clear effect of inhibiting NOx formation. In addition, the Cu-containing Fe-beta zeolite was a catalyst for the oxidative degradation of ammonia, which had excellent low-temperature activity and could effectively inhibit NOx caused by side reactions.

### MODE FOR THE INVENTION

The above-described inventive catalyst can be supported on a metal or ceramic honeycomb and be used in an exhaust treatment system for the oxidation of unreacted ammonia contained in exhaust gas emitted from mobile internal combustion engines such as diesel engines and gasoline engines. Also, the inventive catalyst can be used in an exhaust gas treatment system in order to minimize the formation of nitrogen oxides caused by slipped ammonia or waste ammonia generated in an SCR or NSCR system and related processes, including ammonia preparation processes, and to effectively oxidize the ammonia.

Specifically, the inventive catalyst can be used in a mobile source system for the treatment of exhaust gas, such as a diesel engine, which comprises (a) an exhaust system through which exhaust gas flows, (b) a selective catalytic reduction catalyst serving to catalyze the reduction of NOx into nitrogen by ammonia and adsorbing and desorbing ammonia during an engine cycle, (c) an ammonia source, (d) a means for supplying ammonia from the ammonia source to said selective catalytic reduction catalyst, and (e) a means for intermittently supplying ammonia during the engine cycle, wherein an ammonia oxidation catalyst comprising either Cu-containing zeolite impregnated with platinum or Cu-containing alumina impregnated with platinum is supported on a monolithic metal or ceramic substrate and is disposed at a stage following the selective catalytic reduction catalyst.

Also, the inventive catalyst can be applied in a fixed source SCR system for the treatment of exhaust gas, which comprises (a) a combustion chamber having no reducing agent-injection unit, (b) a waste heat boiler through which exhaust gas generated in the combustion chamber flows, (c) a dry, semi-dry or wet reaction column, (d) a bag filter, (e) an SCR exhaust treatment system including an ammonia-reducing agent supply unit and a catalyst column, and (f) a means for emitting exhaust gas, wherein an ammonia oxidation catalyst comprising either Cu-containing zeolite impregnated with platinum or Cu-containing alumina impregnated with platinum is supported on a monolithic metal or ceramic substrate and is disposed at a stage following the catalyst column.

### INDUSTRIAL APPLICABILITY

In addition, the inventive catalyst can be applied in a fixed source NSCR system for the treatment of exhaust gas, which comprises (a) a combustion chamber equipped with a reducing agent-injection unit, (b) a waste heat boiler, (c) a reaction column, (d) a bag filter, and (e) a means for emitting exhaust gas, wherein an ammonia oxidation catalyst comprising either Cu-containing zeolite impregnated with platinum or Cu-containing alumina impregnated with platinum is supported on a monolithic metal or ceramic substrate and is disposed at a stage following the combustion chamber.

1. An ammonia oxidation catalyst comprising either Cu-containing zeolite impregnated with platinum or Cu-containing alumina impregnated with platinum.

2. The ammonia oxidation catalyst of claim 1, wherein the zeolite is beta zeolite.

3. The ammonia oxidation catalyst of claim 2, wherein the beta-zeolite is Fe-beta zeolite.

4. The ammonia oxidation catalyst of claim 1, wherein the alumina is further impregnated with Si.

5. The ammonia oxidation catalyst of claim 1, wherein the zeolite is a zeolite impregnated with less than 1.0 wt % platinum and containing less than 10 wt % copper.

6. A mobile source system for the treatment of exhaust gas, which comprises (a) an exhaust system through which exhaust gas flows, (b) a selective catalytic reduction catalyst serving to catalyze the reduction of NOx into nitrogen by ammonia and adsorbing and desorbing ammonia during an engine cycle, (c) an ammonia source, (d) a means for supplying ammonia from the ammonia source to said selective catalytic reduction catalyst, and (e) a means for intermittently supplying ammonia during the engine cycle, wherein an ammonia oxidation catalyst comprising either Cu-containing zeolite impregnated with platinum or Cu-containing alumina impregnated with platinum according to claim 1 is supported on a monolithic metal or ceramic substrate and disposed at a stage following the selective catalytic reduction catalyst.

7. A fixed source SCR system for the treatment of exhaust gas, which comprises (a) a combustion chamber having no reducing agent-injection unit, (b) a waste heat boiler through which exhaust gas generated in the combustion chamber flows, (c) a dry, semi-dry or wet reaction column, (d) a bag filter, (e) an SCR exhaust treatment system including an ammonia-reducing agent supply unit and a catalyst column, and (f) a means for emitting exhaust gas, wherein an ammonia oxidation catalyst comprising either Cu-containing zeolite impregnated with platinum or Cu-containing alumina impregnated with platinum according to claim 1 is supported on a monolithic metal or ceramic substrate and disposed at a stage following the catalyst column.

8. A fixed source NSCR system for the treatment of exhaust gas, which comprises (a) a combustion chamber equipped with a reducing agent-injection unit, (b) a waste heat boiler, (c) a reaction column, (d) a bag filter, and (e) a means for emitting exhaust gas, wherein an ammonia oxidation catalyst comprising either Cu-containing zeolite impregnated with platinum or Cu-containing alumina impregnated with platinum according to claim 1 is supported on a monolithic metal or ceramic substrate and disposed at a stage following the combustion chamber.

9. The ammonia oxidation catalyst of claim 2, wherein the zeolite is a zeolite impregnated with less than 1.0 wt % platinum and containing less than 10 wt % copper.

10. The ammonia oxidation catalyst of claim 3, wherein the zeolite is a zeolite impregnated with less than 1.0 wt % platinum and containing less than 10 wt % copper.
